(19) United States
(12) Patent Application Publication
(10) Pub. No.: US 2022/0344067 A1
(43) Pub. Date: Oct. 27, 2022

(54) SPACE NUCLEAR PROPULSION REACTOR AFT PLENUM ASSEMBLY

(71) Applicant: BWXT Nuclear Energy, Inc., Lynchburg, VA (US)

(72) Inventors: Matthew W. Ales, Puyallup, WA (US); Emily D. Fleming, Forest, VA (US); Ted L. Thome, Cuyahoga Falls, OH (US)

(21) Appl. No.: 17/731,003

(22) Filed: Apr. 27, 2022

Related U.S. Application Data
(60) Provisional application No. 63/180,357, filed on Apr. 27, 2021.

(51) Int. Cl. G21C 15/253; G21C 1/32; G21D 5/02

(52) U.S. Cl. CPC G21C 15/253; G21C 1/322; G21C 1/324; G21D 5/02

(57) ABSTRACT

An aft plenum assembly for use with a nuclear thermal reactor including a pressure vessel and a nozzle assembly having a top plenum plate disposed within the pressure vessel, the top plenum plate defining a first plurality of fuel flow apertures, a bottom plenum plate disposed within the pressure vessel, the bottom plenum plate being parallel to the top plenum plate thereby defining a plenum space therebetween, the bottom plenum plate defining a second plurality of fuel flow apertures, and a plurality of tubular connections extending between the first plurality of fuel flow apertures of the top plenum plate and the second plurality of fuel flow apertures of the bottom plenum plate, wherein the aft plenum assembly is disposed between the pressure vessel and the nozzle assembly.

### CLAIM OF PRIORITY

This application claims priority to U.S. provisional patent application No. 63/180,357 filed Apr. 27, 2021, the disclosure of which is incorporated by reference herein.

### GOVERNMENT SUPPORT CLAUSE

The invention described herein was made with government support under Subcontract No. 00212687 to DOE Award No. DE-AC07-05ID14517 and NASA Prime Contract 80MSFC17C0006 and is subject to the provisions of section 20135 of the National Aeronautics and Space Act (51 U.S.C. § 20135). The Government has certain rights in the invention.

### TECHNICAL FIELD

The presently-disclosed invention relates generally to nuclear reactors and, more specifically, to internal support structures for supporting various internal components of nuclear reactors used in nuclear thermal propulsion.

### BACKGROUND

The concept of utilizing nuclear thermal propulsion (NTP) to propel spacecraft during space travel is known. Nuclear thermal propulsion has been studied and tested in both the US and former Soviet Union (FSU). Most reactor arrangements utilize separate fuel assemblies and moderator assemblies “hung” from a support structure at the forward end of the reactor. Reactor designs based on the use of a slab moderator configuration have also been developed. Examples include the Experimental Beryillim Oxide Reactor (EBOR) which utilizes cylindrical assemblies inserted into blocks of BeO, the High Temperature Reactor Experiment (HTRE) design which utilized solid moderator blocks of zirconium hydride in a similar arrangement, and the Space Nuclear Thermal Propulsion (SNTP) reactor which utilized cylindrical assemblies inserted into hexagonal blocks of moderator. While not a solid moderator block, a similar heterogeneous fuel/moderator arrangement was used for the Gas-Cooled Reactor Experiment (GCRE).

These fore-side supported configurations place the support at the cold end of the reactor core. However, the flow channel paths are particularly complicated, there are many sub-assemblies, and it is challenging to keep the aft end of the moderator assemblies cool and limit thermal stress since they are adjacent to the fuel assemblies. Furthermore, support from only the forward end places the moderator and fuel assemblies in tension and failures of either may be particularly catastrophic. However, there is little design data on prior configurations of aft side supported configurations and no workable configuration demonstrated for a SNP/NTP engine with integral reactor concept making use of high assay low enriched uranium (HALEU).

Moderator block reactor arrangements require that the moderator be supported and flow distributed into it from the aft end of reactor. While fuel assemblies can be supported from the forward end, that configuration requires a sliding seal at the end of the fuel assembly so the fuel assemblies are also supported from the aft (nozzle) end for the moderator block arrangement. Aft-side support structures must distribute hydrogen provided to the reactor for moderator cooling to the cooling channels in the moderator while interacting with nozzle exit temperatures immediately adjacent to it. The support structure must further transmit the loads from pressure differentials and from core mass/accelerations to the reactor vessel.

There at least remains a need, therefore, for improved devices for NTP engines that can support moderator block configurations while providing adequate cooling flow and support for the fuel and moderator block assemblies.

### SUMMARY OF INVENTION

One embodiment of the present disclosure includes an aft plenum assembly for use with a nuclear thermal reactor including a pressure vessel and a nozzle assembly having a top plenum plate disposed within the pressure vessel, the top plenum plate defining a first plurality of fuel flow apertures, a bottom plenum plate disposed within the pressure vessel, the bottom plenum plate being parallel to the top plenum plate thereby defining a plenum space therebetween, the bottom plenum plate defining a second plurality of fuel flow apertures, and a plurality of tubular connections extending between the first plurality of fuel flow apertures of the top plenum plate and the second plurality of fuel flow apertures of the bottom plenum plate, wherein the aft plenum assembly is disposed between the pressure vessel and the nozzle assembly.

Another embodiment of the present disclosure provides a nuclear thermal reactor having a reactor pressure vessel defining an interior volume, a reactor core including a plurality of fuel assemblies and moderator assemblies, the reactor core being disposed within the interior volume of the reactor pressure vessel, and an aft plenum assembly including a top plenum plate disposed within the pressure vessel, the top plenum plate defining a first plurality of fuel flow apertures, a bottom plenum plate disposed within the pressure vessel, the bottom plenum plate being parallel to the top plenum plate thereby defining a plenum space therebetween, the bottom plenum plate defining a second plurality of fuel flow apertures, and a plurality of tubular connections extending between the first plurality of fuel flow apertures of the top plenum plate and the second plurality of fuel flow apertures of the bottom plenum plate, wherein the aft plenum assembly is disposed between the pressure vessel and the nozzle assembly, and the reactor core is supported on the aft plenum assembly.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

The invention now will be described more fully hereinafter with reference to the accompanying drawings, in which some, but not, all embodiments of the invention are shown. Indeed, this invention may be embodied in many different forms and should not be construed as limited to the embodiments set forth herein; rather, these embodiments are provided so that this disclosure will satisfy applicable legal requirements.

FIGS. 1A and 1B are cross-sectional views of a nuclear thermal propulsion rocket engine including an aft plenum assembly as shown in FIGS. 2 through 5;

FIGS. 2A and 2B are partial cross-sectional views of an aft plenum assembly of the nuclear thermal propulsion rocket engine shown in FIGS. 1A and 1B;

FIG. 3 is a partial cross-sectional view of the aft plenum assembly shown in FIGS. 1A and 1B, showing detail of the thermal shield;

FIG. 4 is a partial cross-sectional view of an aft plenum assembly in accordance with an alternate embodiment of the present invention;

FIG. 5 is a partial cross-sectional view of an aft plenum assembly in accordance with an alternate embodiment of the present invention;

FIG. 6 is a partial cross-sectional view of an aft plenum assembly in accordance with an alternate embodiment of the present invention;

FIG. 7 is a partial cross-sectional view of an aft plenum assembly in accordance with an alternate embodiment of the present invention;

FIG. 8 is a perspective view of a flow adapter plate for use with embodiments of aft plenum assemblies as shown in FIGS. 2 through 5; and

FIGS. 9A and 9B are a full and a partial perspective view, respectively, of an alternate embodiment of an aft plenum assembly including the flow adapter plate as shown in FIG. 8.

Repeat use of reference characters in the present specification and drawings is intended to represent same or analogous features or elements of the invention according to the disclosure.

### DETAILED DESCRIPTION

The invention now will be described more fully hereinafter with reference to the accompanying drawings, in which some, but not, all embodiments of the invention are shown. Indeed, this invention may be embodied in many different forms and should not be construed as limited to the embodiments set forth herein; rather, these embodiments are provided so that this disclosure will satisfy applicable legal requirements.

As used herein, terms referring to a direction or a position relative to the orientation of the fuel-fired heating appliance, such as but not limited to “vertical,” “horizontal,” “upper,” “lower,” “above,” or “below,” refer to directions and relative positions with respect to the appliance's orientation in its normal intended operation, as indicated in the Figures herein. Thus, for instance, the terms “vertical” and “upper” refer to the vertical direction and relative upper position in the perspectives of the Figures and should be understood in that context, even with respect to an appliance that may be disposed in a different orientation.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

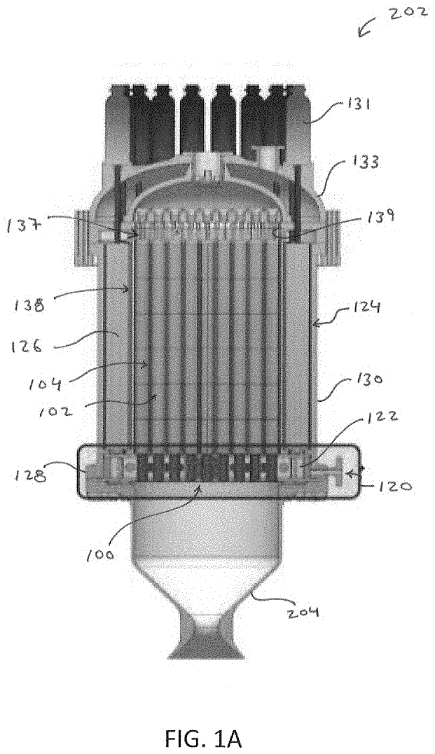

Referring now to FIGS. 1A and 1B, hydrogen gas is used to cool the Nuclear Thermal Propulsion (NTP) reactor components as well as provide propellant for the thrust produced by the NTP rocket engine 200. In order for the NTP reactor 202, which in the present example utilizes high assay low enriched uranium (HALEU), to go critical and generate heat in the reactor fuel, enriched uranium nuclear reactors rely on neutron moderating materials to thermalize, or slow, neutrons released in the fission process. The moderation of neutrons in a nuclear reactor's core is required to sustain the nuclear chain reaction in the core, thereby producing heat. The moderating material must be cooled in order to prevent melting. The same hydrogen gas that is utilized in cooling the moderator material is also routed through other areas of the reactor as coolant. Ultimately, the hydrogen gas exits the reactor by passing through, and being heated within, the fuel elements, thereby producing thrust as it exits the nozzle assembly 204. As discussed in greater detail below, the moderator assemblies 102 and fuel assemblies 104 of the reactor core of the NTP reactor 202 are supported by an aft plenum assembly 100 in accordance with the present invention.

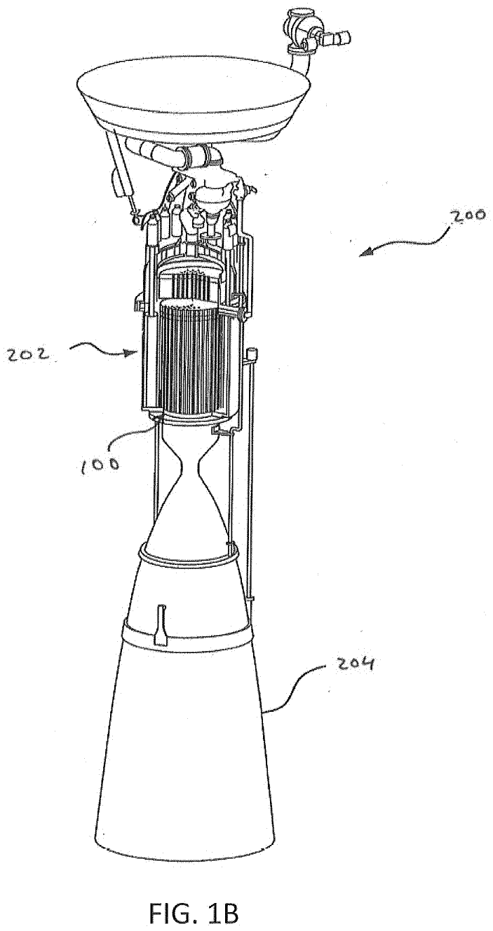

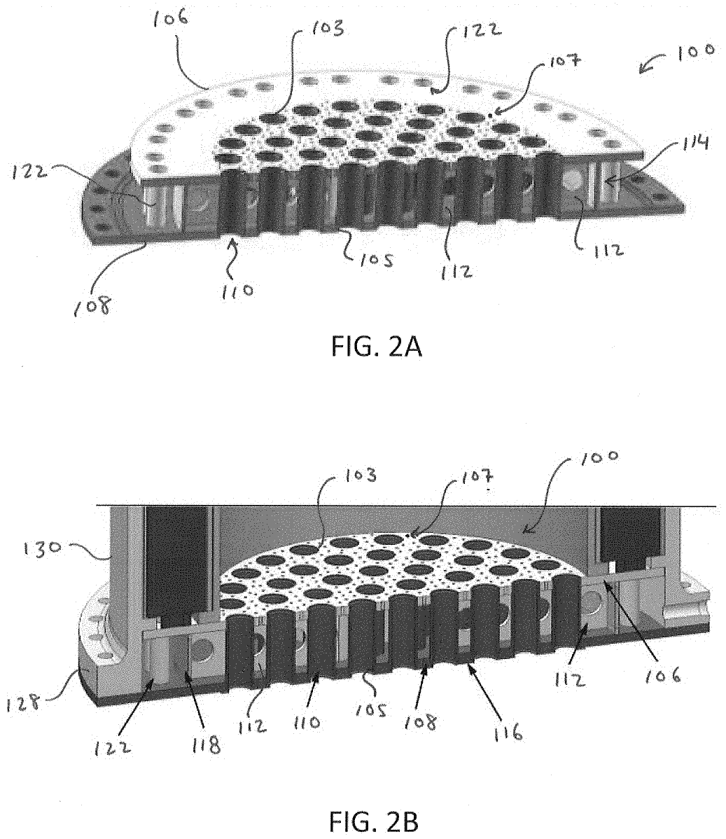

The purpose of the aft plenum assembly 100, the position of which within the NTP reactor 202 is shown as region (A) in FIG. 1A, is to support the moderator assemblies 102 and fuel assemblies 104 of the moderator block reactor of the NTP/SNP rocket engine and to distribute the hydrogen coolant uniformly to the cooling channels in the moderator assembly 102. Referring additionally to FIGS. 2A and 2B, the aft plenum assembly 100 preferably includes a top plenum plate 106, a bottom plenum plate 108, and a plurality of tubular connections 110 extending therebetween. Each tubular connection 110 connects fuel flow apertures 103 and 105 defined in the top and bottom plenum plates 106 and 108, respectively. As well, each tubular connection 110 is positioned and configured to allow a portion of a corresponding fuel assembly 104 to protrude therethrough, as best seen in FIG. 3. Shear webs 112 connect the top and bottom plenum plates 106 and 108 in the manner of an I-beam configuration for an improved strength to weight ratio. The space between the top and bottom plenum plates 106 and 108 forms a plenum 114 that feeds the moderator cooling channels via coolant flow holes 107 in the top plenum plate 106. In the preferred embodiment shown, the top and bottom plenum plates 106 and 108 are preferably constructed of Ti8Al1Mo1V, although alternate materials may be used.

A thermal shield 116 is located on the nozzle side of the bottom plenum plate 108, which is shown in greater detail in FIG. 3. Note, FIG. 3 also includes a partial view of some components of the fuel assemblies 104 therein. Although the preferred materials of the components of the aft plenum assembly 100 are capable of withstanding temperatures expected in the nozzle assembly 204, the thermal shield 116 reduces material temperatures allowing for thinner, lighter components to meet the desired stress limits. Furthermore, the thermal shield 116 reduces heat transfer from the nozzle assembly 204 to the hydrogen gas located in the plenum region 114. The reduced heat transfer from the nozzle assembly 204 to the hydrogen gas in the plenum region 114 results in higher engine specific impulse (Isp) and more uniform distribution of the hydrogen coolant to the moderator cooling channels. As shown, the thermal shield 116 includes a shield plate 117 that is preferably constructed of Tungsten and spaced from the bottom surface of the bottom plenum plate 108 of the aft plenum assembly 100, thereby defining a gap 119 therebetween. The gap 119 of the thermal shield 116 collects hydrogen gas therein that cools due to becoming stagnant, thereby forming an insulative layer between the nozzle assembly 204 and the bottom plenum plate 108 of the aft plenum assembly 100. Note also, an annular gap 121 exists between each tubular connection 110 of the aft plenum assembly 100 and the fuel assembly 104 components disposed therein. The annular gaps 121 have a similar insulative effect as the gap 119 of the thermal shield 116 as they are filled with hydrogen.

As shown in FIGS. 2A and 2B, the aft plenum assembly 100 also includes a flow distribution ring 118. The flow distribution ring 118 includes a cylindrical side wall that extends between the top and bottom plenum plates 106 and 108, thereby encircling the plurality of tubular connection 110 through which portions of the flow assemblies 104 pass. The cylindrical side wall of the flow distribution ring 118 is perforated so that the hydrogen coolant which enters the plenum 114 from three aft moderator inlet nozzles 120 is spread around the perimeter of the plenum 114 before flowing radially inward to both cool the structure and feed the moderator cooling channels. Still referring again to FIGS. 2A and 2B, toward the periphery of the aft plenum assembly 100, a plurality of flow tubes 122 allows flow from the regeneratively cooled nozzle assembly 204 to feed into the reflector region 124 of the rocket engine 200 where the reactor control drums 126 are located. As shown in FIG. 1A, the reactor control drums 126 are each selectively driven by a corresponding control drum drive assembly 131 that is disposed above the reactor head 133. The reactor head 133 and reactor vessel 130 support a fore support plate 137 that includes flow inlets 139 for the fuel assemblies 104.

As noted, hydrogen coolant enters the outer region of the aft plenum assembly 100 from three discrete aft moderator inlet nozzles 120 defined within the flange 128 of the reactor vessel 130, as best seen on the right side of FIG. 2B. Hydrogen coolant flow distributes around the perimeter of the aft plenum assembly 100 due to the flow distribution ring 118, after which it feeds radially inward. As the coolant flows inward, it not only cools the structure of the aft plenum assembly 100, but also feeds the moderator cooling channels via holes 107 in the top plenum plate 106. Simultaneously, the structure is withstanding a differential pressure between the plenum region/moderator region and the nozzle region which may be on the order of 6 to 10 MPa, although various pressure ranges are possible.

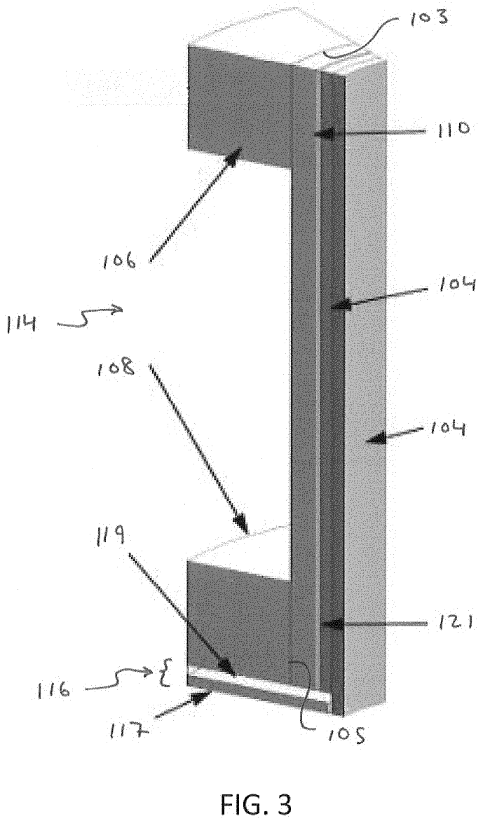

Alternate embodiments of aft plenum assemblies in accordance with the present invention are shown in FIGS. 4 through 7. FIG. 4 shows alternatives to the nozzle side thermal shield 116 which is discussed above with regard to FIG. 3. Specifically, rather than utilizing a shield plate 117 to form a gap 119 between the shield plate 117 and the bottom surface of the bottom plenum plate 108, as shown in FIG. 3, a flow baffle plate 134 is mounted to the bottom surface of the top plenum plate 106. The flow baffle 134 preferably includes a cylindrical side wall 141, and a circular bottom wall 143 defining a plurality of apertures 145 through which portions of the tubular connections 110 extend. As shown, whereas the majority of the apertures 145 do not allow flow therethrough, one or more central apertures 145a have a diameter that is greater than that of the corresponding tubular connection 110 that extends therethrough. As such, the moderator cooling gas flows radially-inwardly between the top surface of the bottom plenum plate 108 and the bottom surface of the bottom wall 143 of the flow baffle 134 before flowing through the central aperture(s) 145a into the cooling channels of the moderator assemblies 102, as shown by the arrows in FIG. 4. The flow baffle 134 is beneficial as it improves the heat transfer coefficient on the plenum 114 side of the bottom plenum plate 108. Note, flow baffle 134 may be used in addition to the nozzle-side thermal shield 116.

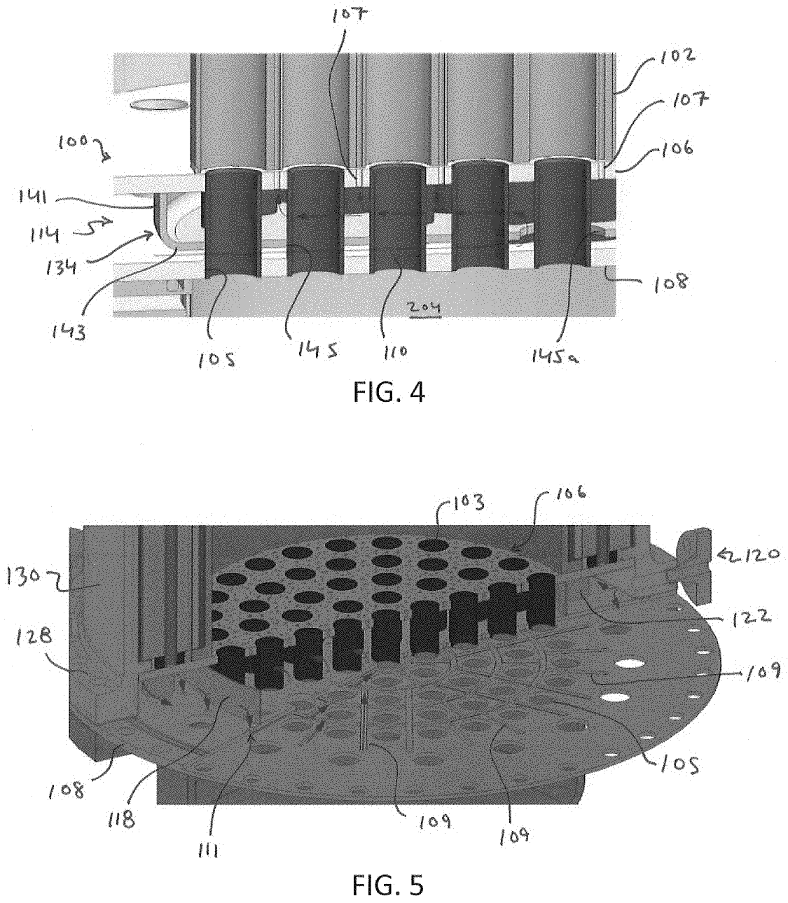

In yet another alternate embodiment shown in FIG. 5, an internally-cooled bottom plenum plate 108 may include passages 109 formed therein to allow coolant flow. Preferably, the top surface of the bottom plenum plate 108 defines a plurality of blind bores 111 that are in fluid communication with the internally-formed passages 109 of the bottom plenum plate 108. Moderator cooling gas flows into a plurality of the blind bores 111 that are disposed outside of the flow distribution ring 118, radially-inwardly through the internal channels 109, and out of the plurality of blind bores 111 that are disposed within the flow distribution ring 118, thereby cooling the bottom plenum plate 108.

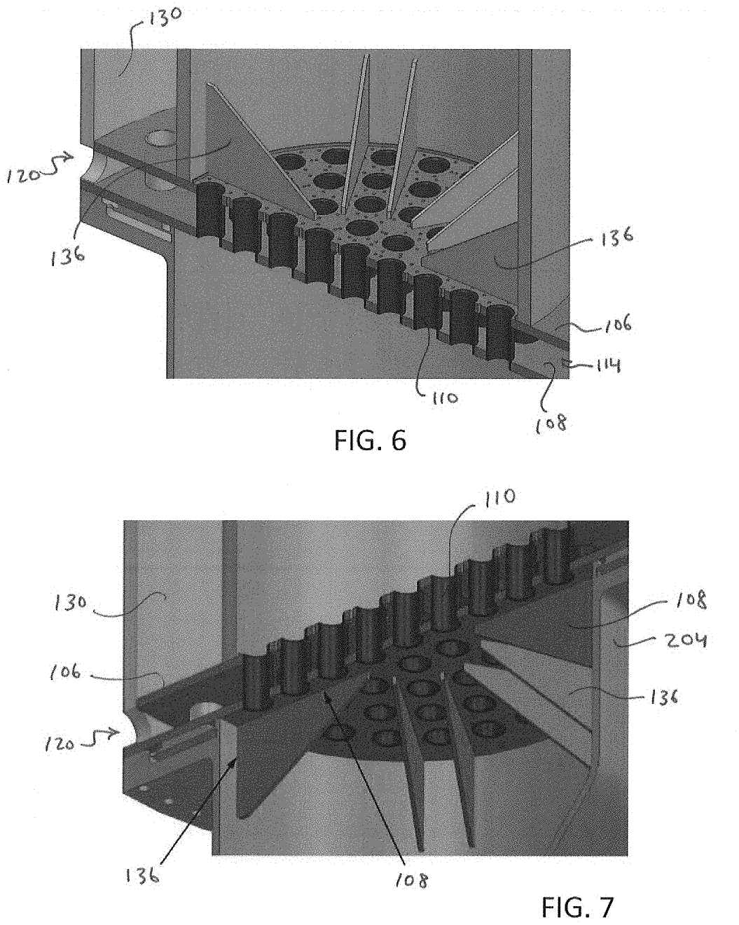

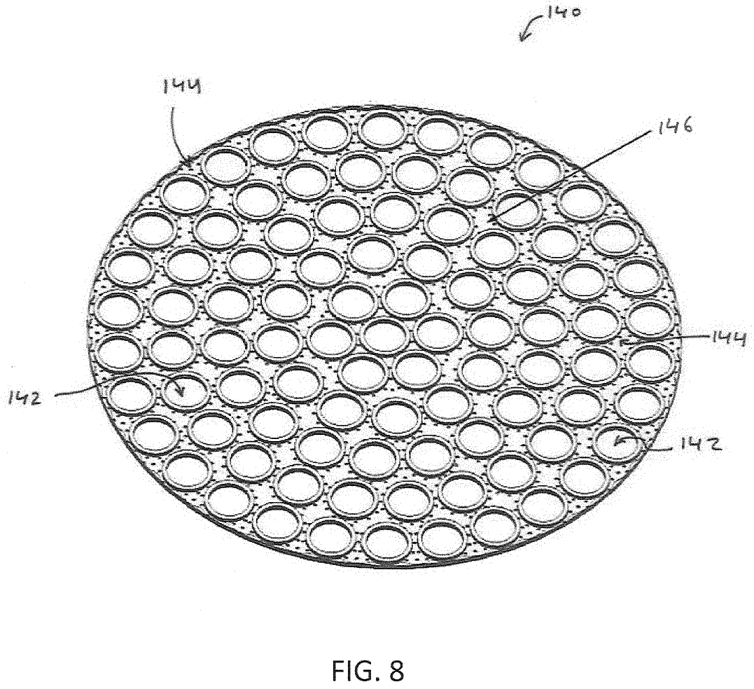

FIGS. 6 and 7 show configurations of the aft plenum assembly 100 that allow the internal shear webs 112 to be omitted. Specifically, gussets 136 may be attached to either the upper surface of top plenum plate 106 or the bottom surface of the bottom plenum plate 108 so that they bear against the inner surface of the core barrel 138 or the inner surface of the nozzle assembly 204, respectively. Note, in the disclosed configurations the gussets 136 are not secured to either the core barrel 138 or the nozzle assembly 204. As noted, the gussets 136 allow for the elimination of the shear webs 112 discussed with regard to the previous embodiments.

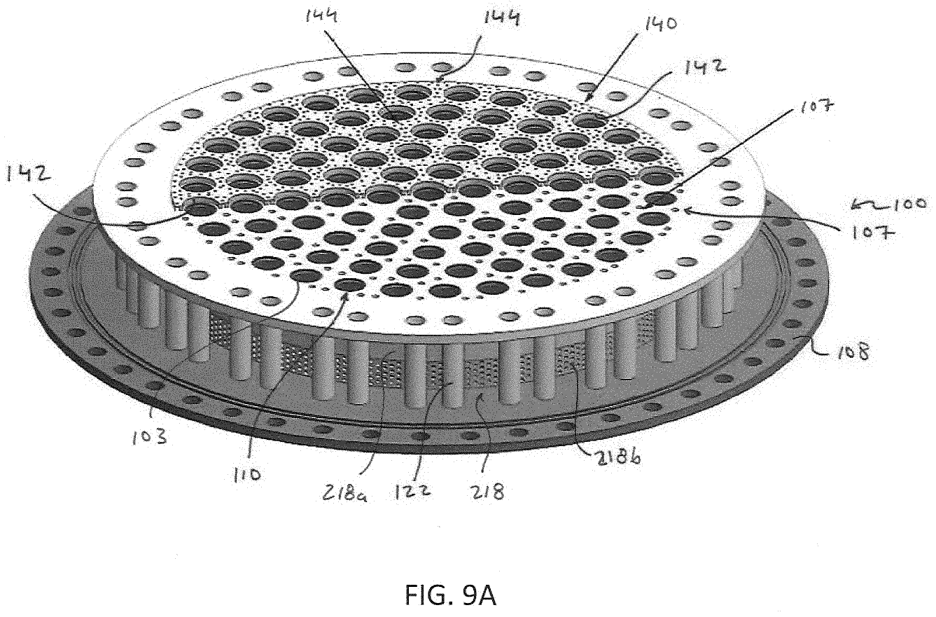

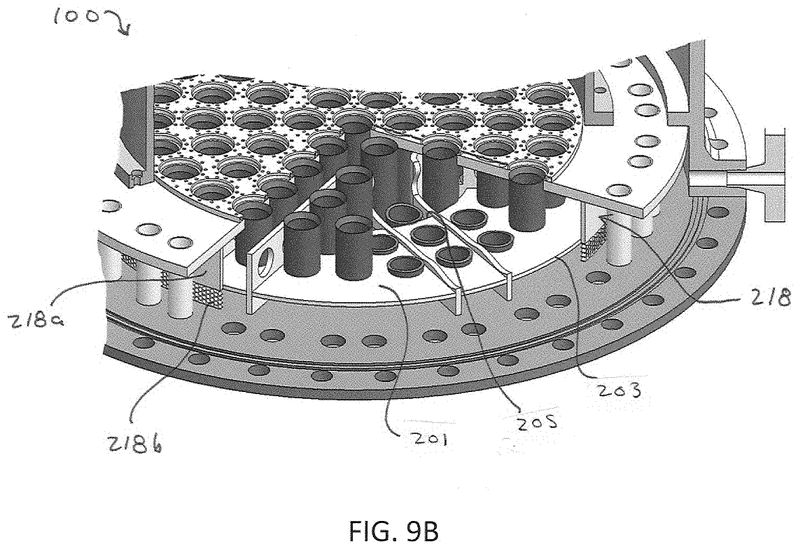

Referring now to FIGS. 8, 9A, and 9B, a flow adapter plate 140 for possible use with the aft plenum assembly 100 is described. The flow adapter plate 140 is received adjacent the upper surface of the top plenum plate 106 and includes a plurality of apertures 142 that correspond to the tubular connections 110 of the aft plenum assembly 100, and a plurality of flow holes 144 formed therein. As shown, a bottom side of the flow adapter plate 140 includes machined-out regions that define a plenum space 146 with the top surface of the top plenum plate 106. Hydrogen coolant that enters plenum space 146 through holes 107 of the top plate 106 then exits the flow holes 144 of the flow adapter plate 140, which are aligned with the flow holes of the moderator assemblies 102. As such, the coolant gas passes upwardly through the flow channel of the moderator assemblies 102, as discussed previously. Note, in an alternate embodiment of the aft plenum assembly 100 in which the flow adapter plate 140 is utilized, the number of holes 107 in the top plenum plate 106 may be greatly reduced by the use of fewer, larger holes 107, on the order of 5 to 6 mm each. The flow adapter plate 140 is preferably made from Ti-8Al-1Mo-1V, and may be either welded or bolted to top plenum plate 106 of the aft plenum assembly 100, or may just be received thereon.

As shown in FIGS. 9A and 9B, an alternate embodiment of the aft plenum assembly 100 includes a flow adapter plate 201 and a flow distribution ring 218 that differs from that of the previously discussed embodiment. As shown, the flow adapter plate 201 is disposed between the top and bottom plenum plates 106 and 108, and parallel to both. The outer perimeter 203 of the flow adapter plate 201 intersects the side wall of the flow distribution ring 218 so that the side wall is operated into a solid top portion 218a and a perforated bottom portion 218b. As such, the cooling flow of gas flows radially-inwardly between the top surface of the bottom plenum plate 108 and the bottom surface of the flow adapter plate 201 before flowing upwardly into the moderator assemblies 102 by way of a central opening 205 defined in the flow adapter plate 201.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

1. An aft plenum assembly for use with a nuclear thermal reactor including a pressure vessel and a nozzle assembly, comprising:
a top plenum plate disposed within the pressure vessel, the top plenum plate defining a first plurality of fuel flow apertures;
a bottom plenum plate disposed within the pressure vessel, the bottom plenum plate being parallel to the top plenum plate thereby defining a plenum space therebetween, the bottom plenum plate defining a second plurality of fuel flow apertures; and
a plurality of tubular connections extending between the first plurality of fuel flow apertures of the top plenum plate and the second plurality of fuel flow apertures of the bottom plenum plate,
wherein the aft plenum assembly is disposed between the pressure vessel and the nozzle assembly.

2. The aft plenum assembly of claim 1, wherein the plenum space is in fluid communication with the moderator assemblies disposed within the pressure vessel.

3. The aft plenum assembly of claim 2, wherein top plenum plate defines a plurality of coolant flow apertures therein.

4. The aft plenum assembly of claim 3, further comprising a flow distribution ring having a cylindrical side wall, wherein the flow distribution ring extends between the top and the bottom plenum plates so that the plurality of tubular connections is encircled by the cylindrical side wall.

5. The aft plenum assembly of claim 4, wherein a portion of the cylindrical side wall of the flow distribution ring is perforated.

6. The aft plenum assembly of claim 5, further comprising a flow adapter plate defining a central aperture therein, wherein the flow adapter plate is disposed between the top and the bottom plenum plates so that the flow adapter plate is parallel to both the top and the bottom plenum plates, and at least one tubular connection extends through the central aperture of the flow adapter plate.

7. The aft plenum assembly of claim 5, wherein the flow distribution ring includes a top side wall portion disposed above the flow adapter plate and a bottom side wall portion disposed below the flow adapter plate, and the bottom side wall portion is the portion of the cylindrical side wall that is perforated.

8. The aft plenum assembly of claim 3, the bottom plenum plate further comprising a first plurality of blind bores and a second plurality of blind bores extending downwardly from a top surface thereof, and a plurality of radially-inwardly depending internal channels defined within the bottom plenum plate, wherein the first plurality of blind bores is disposed externally to the flow distribution ring, the second plurality of blind bores are disposed internally of the flow distribution ring, and the first and the second pluralities of blind bores are in fluid communication with the internal channels.

9. The aft plenum assembly of claim 3, wherein the reactor core is supported on the top aft plenum assembly.

10. The aft plenum assembly of claim 1, further comprising a thermal shield formed by a shield plate disposed parallel to a bottom surface of the bottom plenum plate so that a gap is disposed therebetween.

11. A nuclear thermal reactor comprising:
a reactor pressure vessel defining an interior volume;
a reactor core including a plurality of fuel assemblies and moderator assemblies, the reactor core being disposed within the interior volume of the reactor pressure vessel; and
an aft plenum assembly comprising:
a top plenum plate disposed within the pressure vessel, the top plenum plate defining a first plurality of fuel flow apertures;
a bottom plenum plate disposed within the pressure vessel, the bottom plenum plate being parallel to the top plenum plate thereby defining a plenum space therebetween, the bottom plenum plate defining a second plurality of fuel flow apertures; and
a plurality of tubular connections extending between the first plurality of fuel flow apertures of the top plenum plate and the second plurality of fuel flow apertures of the bottom plenum plate,
wherein the aft plenum assembly is disposed between the pressure vessel and the nozzle assembly, and the reactor core is supported on the aft plenum assembly.

12. The nuclear thermal reactor of claim 11, wherein the plenum space is in fluid communication with the moderator assemblies of the reactor core.

13. The nuclear thermal reactor of claim 12, wherein top plenum plate defines a plurality of coolant flow apertures therein.

14. The nuclear thermal reactor of claim 13, further comprising a flow distribution ring having a cylindrical side wall, wherein the flow distribution ring extends between the top and the bottom plenum plates so that the plurality of tubular connections is encircled by the cylindrical side wall.

15. The nuclear thermal reactor of claim 14, wherein a portion of the cylindrical side wall of the flow distribution ring is perforated.

16. The nuclear thermal reactor of claim 15, further comprising a flow adapter plate defining a central aperture therein, wherein the flow adapter plate is disposed between the top and the bottom plenum plates so that the flow adapter plate is parallel to both the top and the bottom plenum plates, and at least one tubular connection extends through the central aperture of the flow adapter plate.

17. The nuclear thermal reactor of claim 15, wherein the flow distribution ring includes a top side wall portion disposed above the flow adapter plate and a bottom side wall portion disposed below the flow adapter plate, and the bottom side wall portion is the portion of the cylindrical side wall that is perforated.

18. The nuclear thermal reactor of claim 13, the bottom plenum plate further comprising a first plurality of blind bores and a second plurality of blind bores extending downwardly from a top surface thereof, and a plurality of radially-inwardly depending internal channels defined within the bottom plenum plate, wherein the first plurality of blind bores is disposed externally to the flow distribution ring, the second plurality of blind bores are disposed internally of the flow distribution ring, and the first and the second pluralities of blind bores are in fluid communication with the internal channels.

19. The nuclear thermal reactor of claim 11, further comprising a thermal shield formed by a shield plate disposed parallel to a bottom surface of the bottom plenum plate so that a gap is disposed therebetween.
